(19) United States
(12) Patent Application Publication
(10) Pub. No.: US 2025/0036206 A1
(43) Pub. Date: Jan. 30, 2025

(54) HAND TRACKING BASED ON WRIST ROTATION AND ARM MOVEMENT

(71) Applicant: Apple Inc., Cupertino, CA (US)

(72) Inventors: Daniel J. Brewer, Redwood City, CA (US); Yirong Tang, Munich (DE); Chase B. Lortie, San Francisco, CA (US)

(21) Appl. No.: 18/761,848

(22) Filed: Jul. 2, 2024

Related U.S. Application Data
(60) Provisional application No. 63/528,528, filed on Jul. 24, 2023.

(51) Int. Cl. G06F 3/01; G02B 27/00; G02B 27/01

(52) U.S. Cl. CPC G06F 3/017; G02B 27/0093; G02B 27/017; G06F 3/012; G06F 3/013

(57) ABSTRACT

Various implementations track hand motion to interpret a scroll movement. For example, an example process may include obtaining sensor data associated with a hand via one or more sensors in a physical environment. The process may further include determining positional data corresponding to three-dimensional (3D) positions of two points on the hand based on the sensor data. The process may further include determining whether a movement of the hand includes a wrist rotation associated with the hand rotating about the wrist, an arm motion associated with movement of the arm, or a combination of the wrist rotation and the arm motion. The process may further include determining the movement of the hand as a user interaction event based on the positional data and whether the movement of the hand includes the wrist rotation, the arm motion, or a combination of the wrist rotation and the arm motion.

### CROSS-REFERENCE TO RELATED APPLICATIONS

This application claims the benefit of U.S. Provisional Application Ser. No. 63/528,528 filed Jul. 24, 2023, which is incorporated herein in its entirety.

### TECHNICAL FIELD

The present disclosure generally relates to systems, methods, and electronic devices for tracking movement of a hand based on determining wrist rotation and arm movement using one or more sensor data signals.

### BACKGROUND

Hand-based input systems for identifying user input and displaying content based on the hand-based user input may be improved with respect to providing means for users to create, edit, view, or otherwise use content in an extended reality (XR) environment, especially when detecting a scrolling movement. For example, placement mechanics for hand-based input systems may track hand motion relative to a user's body for three-dimensional (3D) object motion, however, existing systems using placement mechanics may exhibit poor scroll sensitivity due to poor interpretation of wrist rotation versus arm movements.

### SUMMARY

Various implementations disclosed herein include devices, systems, and methods that tracks hand motion (e.g., hand moving while a finger pinches) and interprets the hand motion as a scroll based on determining scroll momentum from the hand motion. The hand motion may be interpreted based on determining whether the hand motion involves the hand moving with the arm, and/or the hand rotating about the wrist (e.g., while the arm rests on a surface).

In some implementations, interpreting the hand motion based on type of motion involves mapping a given hand motion to more/less velocity or distance based on the type(s) of motion involved. Doing so may provide a more sensitive/responsive mode for motion that is mostly wrist-based than for motion that is mostly whole arm-based, such that user interface elements may be scrolled more and/or more quickly for wrist-based scroll motions. In another example, interpreting the hand motion based on type of motion involves interpreting the hand motion using a reference (e.g., a pivot point or coordinate system) that is selected based on the type of motion. In some implementations, the hand motion tracking and motion type identification may be based on tracking two points, a wrist pivot point (e.g., approximating a wrist joint), and a pinch centroid.

In general, one innovative aspect of the subject matter described in this specification can be embodied in methods that include the actions of, at a device having a processor and one or more sensors, obtaining sensor data associated with a hand via the one or more sensors in a physical environment, the hand including a wrist and is associated with an arm, determining positional data corresponding to three-dimensional (3D) positions of two points on the hand based on the sensor data, based on the determined positional data, determining whether a movement of the hand includes a wrist rotation associated with the hand rotating about the wrist, an arm motion associated with movement of the arm, or a combination of the wrist rotation and the arm motion, and determining the movement of the hand as a user interaction event based on the positional data and whether the movement of the hand includes the wrist rotation, the arm motion, or a combination of the wrist rotation and the arm motion.

These and other embodiments may each optionally include one or more of the following features.

In some aspects, a sensitivity of determining the movement of the hand as the user interaction event is increased based on determining the movement of the hand includes at least the wrist rotation.

In some aspects, determining the movement of the hand based on the determined positional data includes determining whether the movement of the hand is classified as a wrist-based motion or an arm-based motion.

In some aspects, the movement of the hand is determined based on a pinch centroid about an arm pivot in response to determining that the movement of the hand is classified as an arm-based motion. In some aspects, the movement of the hand is determined based on a pinch centroid about an arm pivot and the pinch centroid about a wrist pivot in response to determining that the movement of the hand is classified as a wrist-based motion.

In some aspects, determining whether the movement of the hand includes wrist rotation includes determining a type of motion based on an amount of wrist movement compared to a threshold. In some aspects, the user interaction event includes a scrolling action.

In some aspects, determining the movement of the hand is based on an angular change. In some aspects, a first point of the two points on the hand includes a wrist joint, and a second point of the two points on the hand includes a pinch centroid associated with at least two fingers of the hand. In some aspects, determining the positional data corresponding to the 3D positions of two points on the hand is initiated based on identifying a pinch action associated with two or more fingers of the hand.

In some aspects, determining the movement of the hand as the user interaction event is initiated based on a first user action. In some aspects, determining the movement of the hand is stopped based on a second user action.

In some aspects, the method further includes the actions of determining a velocity of the movement of the hand and updating the positional data corresponding to the 3D positions of the two points on the hand based on the velocity of the hand exceeding a threshold. In some aspects, the method further includes the actions of obtaining a second sensor data signal associated with a pose of a head or a device worn on the head via the one or more sensors in the physical environment.

In some aspects, the method further includes the actions of determining changes in the pose of the head or the device, updating the positional data corresponding to the 3D positions of the two points on the hand based on detecting rotation or movement of the head or the device based on the determined changes in the pose of the head or the device.

In some aspects, the hand is a first hand, the sensor data is obtained during a period of time and the movement of the hand is determined during the period of time, and the method further includes the actions of obtaining another sensor data associated with a second hand via the one or more sensors in the physical environment during the period of time, determining additional positional data corresponding to 3D positions of two points on the second hand based on the sensor data during the period of time, and determining the movement of the second hand as the user interaction event based on the additional positional data and whether the movement of the second hand includes the second hand rotating about the wrist.

In some aspects, determining the movement of the hand as the user interaction event based on the positional data and whether the movement of the hand includes the hand rotating about the wrist is further based on determining a direction of a gaze. In some aspects, determining the movement of the hand as the user interaction event based on the positional data and whether the movement of the hand includes the hand rotating about the wrist is further based on tracking a viewpoint or a pose of the hand. In some aspects, determining movement of the hand includes generating a 3D representation of the multiple portions of the hand.

In some aspects, the sensor data includes multiple sensor data signals. In some aspects, the sensor data includes at least one of light intensity image data, depth data, user interface position data, motion data, or a combination thereof. In some aspects, the device includes a head mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIGS. 2A and 2B illustrate views of an XR environment provided by the device of FIG. 1, including identifying hand-based user input in accordance with some implementations.

FIG. 3 illustrates tracking hand motion based on positional data for two points on the hand for hand-based user input in accordance with some implementations.

FIG. 4A illustrates tracking hand motion based on arm motion for hand-based user input in accordance with some implementations.

FIG. 4B illustrates tracking hand motion based on wrist rotation and arm motion for hand-based user input in accordance with some implementations.

FIG. 5 is a flowchart illustrating a method for determining movement of a hand for a user interaction event in accordance with some implementations.

FIG. 6 is a block diagram of an electronic device of in accordance with some implementations.

FIG. 7 is a block diagram of an exemplary head-mounted device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

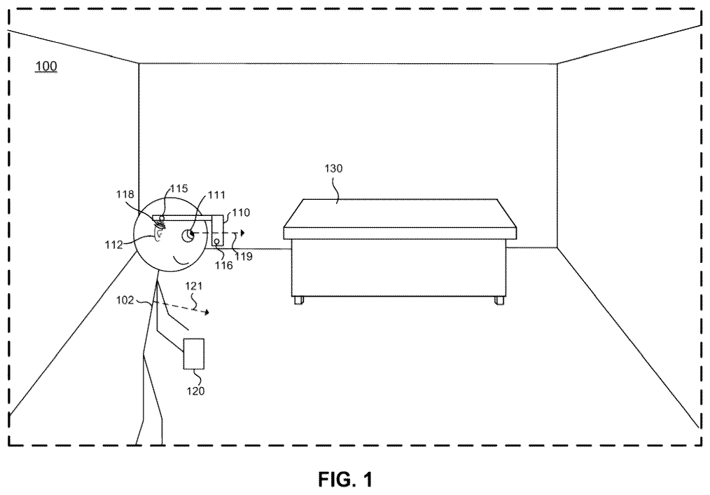

FIG. 1 illustrates a real-world physical environment 100 including a user 102 wearing a device 110 and holding a device 120, and a desk 130. In some implementations, the device 110 is configured to provide content based on one or more sensors on the device 110 or to share information and/or sensor data with other devices. In some implementations, the device 110 provides content that provides augmentations in XR using sensor data. The sensor data may be used to understand a user's head motion attribute associated with head motion while tracking head, body, and/or hand movements.

In the example of FIG. 1, the device 110 includes one or more sensors 116 that capture light-intensity images, depth sensor images, audio data or other information about the user 102 and the physical environment 100. For example, the one or more sensors 116 may capture images of the user's forehead, eyebrows, eyes, eye lids, cheeks, nose, lips, chin, face, head, hands, wrists, arms, shoulders, torso, legs, or other body portions. Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

One or more sensors, such as one or more sensors 115 on device 110, may identify user information based on proximity or contact with a portion of the user 102. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 102 is facing.

Content may be visible, e.g., displayed on a display of device 110, or audible, e.g., produced as audio 118 by a speaker of device 110. In the case of audio content, the audio 118 may be produced in a manner such that only user 102 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 102.

In some implementations, the content provided by the device 110 and sensor features of device 110 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

In some implementations, device 110 is a head mounted device (HMD) that present visual or audio content (e.g., extended reality XR content) or have sensors that obtain sensor data (e.g., visual data, sound data, depth data, ambient lighting data, etc.) about the environment 100 or sensor data (e.g., visual data, sound data, depth data, physiological data, etc.) about the user 102 (or other users). Such information may, subject to user authorizations, permissions, and preferences, be shared amongst the device 110, device 120, and other user devices to enhance the user experiences on such devices.

In some implementations, the device 110 obtains physiological data (e.g., EEG amplitude/frequency, pupil modulation, eye gaze saccades, etc.) from the user via one or more sensors that are proximate or in contact with the user 102. For example, the device 110 may obtain pupillary data (e.g., eye gaze characteristic data) from an inward facing eye tracking sensor. In some implementations, the device 110 include additional sensors for obtaining image or other sensor data of the physical environment 100.

In some implementations, the device 110 is a wearable devices such as ear-mounted speaker/microphone devices (e.g., headphones, ear pods, etc.), smart watches, smart bracelets, smart rings, smart/AR glasses, or other head-mounted devices (HMDs). In some implementations, the device 110 may be a handheld electronic device (e.g., smartphones or tablets, such as device 120). In some implementations, the device 110 is a laptop computer or desktop computer. In some implementations, the device 110 has input devices such as audio command input systems, gesture recognition-based input systems, touchpads or touch-sensitive displays (also known as a “touch screen” or “touch screen display”). In some implementations, multiple devices are used together to provide various features. For example, a smart phone such as device 120 (connected wirelessly and interoperating with wearable device(s)) may provide computational resources, connections to cloud or internet services, location services, etc.

In some implementations, data is shared amongst a group of devices to improve user state or environment understanding. For example, device 120 may share information (e.g., images, audio, or other sensor data) corresponding to user 102 or the physical environment 100 (including information about other users) with device 110 so that device 110 can better understand user 102 and physical environment 100. In some implementations, as illustrated in FIG. 1, the device 120 is a handheld electronic device (e.g., a smartphone or a tablet). In some implementations the device 120 is a laptop computer or a desktop computer. In some implementations, the device 120 has a touchpad and, in some implementations, the device 120 has a touch-sensitive display (also known as a “touch screen” or “touch screen display”). In some implementations, the device 120 is a wearable device such as an HMD, such as device 110.

FIG. 1 illustrates an example in which the devices within the physical environment 100 include HMD device 110. Numerous other types of devices may be used including mobile devices, tablet devices, wearable devices, hand-held devices, personal assistant devices, AI-assistant-based devices, smart speakers, desktop computing devices, menu devices, cash register devices, vending machine devices, juke box devices, or numerous other devices capable of presenting content, capturing sensor data, or communicating with other devices within a system, e.g., via wireless communication. For example, assistance may be provided to a vision impaired person to help the person understand a menu by providing data from the menu to a device being worn by the vision impaired person, e.g., enabling that device to enhance the user's understanding of the menu by providing visual annotations, audible cues, etc.

In some implementations, the device 110 may include eye tracking systems for detecting eye position and eye movements. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, an illumination source on a device may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown the device. Additional cameras may be included to capture other areas of the user (e.g., an HMD with a jaw cam to view the user's mouth, a down cam to view the body, an eye cam for tissue around the eye, and the like). These cameras and other sensors can detect motion of the body, or signals of the face modulated by the breathing of the user (e.g., remote PPG).

In some implementations, the device 110 have graphical user interfaces (GUIs), one or more processors, memory and one or more modules, programs or sets of instructions stored in the memory for performing multiple functions. In some implementations, the user 102 may interact with a GUI through voice commands, finger contacts on a touch-sensitive surface, hand/body gestures, remote control devices, or other user input mechanisms. In some implementations, the functions include viewing/listening to content, image editing, drawing, presenting, word processing, website creating, disk authoring, spreadsheet making, game playing, telephoning, video conferencing, e-mailing, instant messaging, workout support, digital photographing, digital videoing, web browsing, digital music playing, or digital video playing. Executable instructions for performing these functions may be included in a computer readable storage medium or other computer program product configured for execution by one or more processors.

In some implementations, the device 110 employ various physiological or behavioral sensor, detection, or measurement systems. Detected physiological data may include, but is not limited to, EEG, electrocardiogramalectromyography (EMG), functional near infrared spectroscopy signal (fNIRS), blood pressure, skin conductance, or pupillary response. Detected behavioral data may include, but is not limited to, facial gestures, facial expressions, body gestures, or body language based on image data, voice recognition based on acquired audio signals, etc.

In some implementations, the device 110 (or other devices) may be communicatively coupled to one or more additional sensors. For example, a sensor (e.g., an EDA sensor) may be communicatively coupled to a device 110 via a wired or wireless connection, and such a sensor may be located on the skin of a user (e.g., on the arm, placed on the hand/fingers of the user, etc.). For example, such a sensor can be utilized for detecting EDA (e.g., skin conductance), heart rate, or other physiological data that utilizes contact with the skin of a user. Moreover, the device 110 (using one or more sensors) may concurrently detect multiple forms of physiological data in order to benefit from synchronous acquisition of physiological data or behavioral data. Moreover, in some implementations, the physiological data or behavioral data represents involuntary data, e.g., responses that are not under conscious control. For example, a pupillary response may represent an involuntary movement. In some implementations, a sensor is placed on the skin as part of a watch device, such as a smart watch.

In some implementations, one or both eyes of a user, including one or both pupils of the user present physiological data in the form of a pupillary response (e.g., eye gaze characteristic data). The pupillary response of the user may result in a varying of the size or diameter of the pupil, via the optic and oculomotor cranial nerve. For example, the pupillary response may include a constriction response (miosis), e.g., a narrowing of the pupil, or a dilation response (mydriasis), e.g., a widening of the pupil. In some implementations, a device may detect patterns of physiological data representing a time-varying pupil diameter. In some implementations, the device may further determine the interpupillary distance (IPD) between a right eye and a left eye of the user.

The user data (e.g., upper facial feature characteristic data, lower facial feature characteristic data, and eye gaze characteristic data, etc.), including information about the position, location, motion, pose, etc., of the head or body of the user, may vary in time and a device 110 (or other devices) may use the user data to track skeletal movements (e.g., body, hands, head, etc.). In some implementations, the user data includes texture data of the facial features such as eyebrow movement, chin movement, nose movement, cheek movement, etc. For example, when a person (e.g., user 102) performs a facial expression or micro expression associated with lack of familiarity or confusion, the upper and lower facial features can include a plethora of muscle movements that are used to assess the state of the user based on the captured data from sensors.

The physiological data (e.g., eye data, head/body data, etc.) and behavioral data (e.g., voice, facial recognition, etc.) may vary in time and the device may use the physiological data or behavioral data to measure a physiological/behavioral response or the user's attention to object or intention to perform an action. Such information may be used to identify a state of the user with respect to whether the user needs or desires assistance.

Information about tracking body and head movements and how a user's own data is used may be provided to a user and the user may be provided the option to opt out of use of their own data and given the option to manually override tracking features. In some implementations, the system is configured to ensure that users' privacy is protected by requiring permissions to be granted before a user state is assessed or other features are enabled.

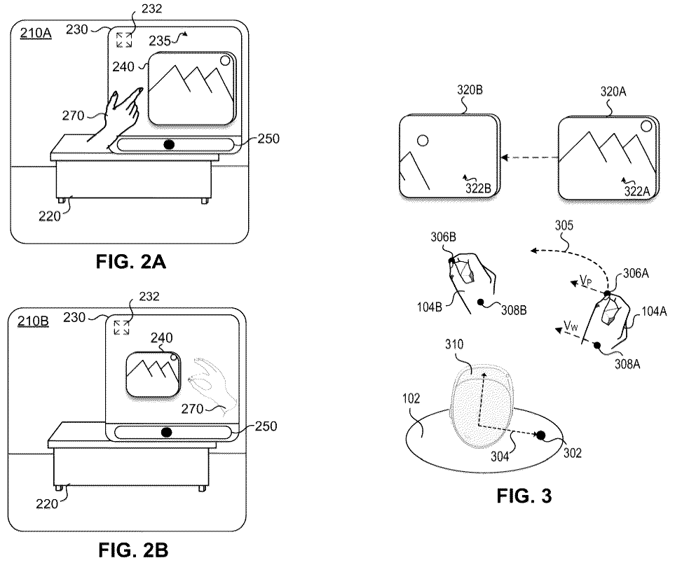

FIGS. 2A and 2B illustrate views of an XR environment 210 provided by the device 110 of FIG. 1, including adjusting hand-based user input in accordance with some implementations. Each FIGS. 2A and 2B includes an exemplary user interface 230 of an application and a depiction 220 of desk 130 (e.g., a representation of a physical object that may be viewed as pass-through video or may be a direct view of the physical object through a transparent or translucent display). Additionally, each FIGS. 2A and 2B includes a representation 270 of a hand/arm of user 102. Providing such a view may involve determining 3D attributes of the physical environment 100 and positioning virtual content, e.g., user interface 230, in a 3D coordinate system corresponding to that physical environment 100.

In the examples of FIGS. 2A and 2B, the user interface 230 include various content items, including a background portion 235, an application portion 240, a control element 232, and a scroll bar 250. The application portion 240 is displayed with 3D effects in the view provided by device 110. The user interface 230 is simplified for purposes of illustration and user interfaces in practice may include any degree of complexity, any number of content items, and/or combinations of 2D and/or 3D content. The user interface 230 may be provided by operating systems and/or applications of various types including, but not limited to, messaging applications, web browser applications, content viewing applications, content creation and editing applications, or any other applications that can display, present, or otherwise use visual and/or audio content.

FIGS. 2A and 2B provide a different user interaction with the content displayed with the user interface 230. For example, FIG. 2A illustrates an XR environment 210A that includes a representation 270 of a hand/arm of user 102 as he or she is about to touch/interact with application content of the application portion 240 (e.g., a user wants to select the application window). FIG. 2B illustrates an XR environment 210B that includes a representation 270 of a hand/arm of user 102 as he or she is interacting with the application window of the application portion 240 using a gesture such as a pinch (e.g., a user wants to collapse or reduce the application window using a pinching motion). In some implementations, a pinch may be utilized as a user interaction event such that a pinch signal initiates a placement gesture.

FIG. 3 illustrates tracking hand motion based on positional data for two points on the hand for hand-based user input in accordance with some implementations. In particular, FIG. 3 illustrates identifying the position of an object (e.g., a hand of user) using sensors (e.g., outward facing image sensors) on a head-mounted device, such as device 310 as the user is moving in the environment and interacting with an environment (e.g., an extended reality (XR) environment). For example, the user may be viewing an XR environment, such as XR environment 210 illustrated in FIGS. 2A and 2B, and interacting with elements within the application window of the user interface (e.g., user interface 230) as the device 310 tracks the hand movements of the user 102.

In some implementations, the positions/movements of the object/hand are tracked at two or more points associated with the hand (e.g., pinch centroid 306 and wrist joint 308) relative to a pivot point/shoulder position (e.g., pivot point 302). The hand tracking system can then determine if the user is trying to interact with particular user interface elements, such as the application environment 322 of the user interface object 320. The user interface object 320 may be virtual content that an application window can allow the user to interact with, and the hand tracking system can determine whether the user is interacting with any particular element or performing a particular motion in a 3D coordinate space such as performing a scroll gesture. For example, hand representation 104A represents the user's 102 right hand at a first instance in time as the user is looking at the user interface object 320A and is performing a user interaction event (e.g., pinching and initiating a scrolling gesture). As the user moves his or her hand for a second instance in time to a position at hand representation 104B, the application can initiate a scrolling action based on detecting a scrolling gesture and move the application environment 322 of the user interface object 320 to the second position as illustrated at user interface object 320B (e.g., move/scroll the content within the application window based on the momentum of the scrolling gesture). Thus, the hand tracking system can track the pinch centroid 306 velocity (V_{P}) and the wrist joint 308 velocity (V_{W}) as the user moves his or her right hand (e.g., hand representation 104B at a second instance of time), and thus the application moves (scrolls) the application environment 322 of the user interface object 320 based on the velocity associated with the hand movements for pinch centroid 306 (V_{P}) and/or wrist joint 308 (V_{W}) as the user is moving along the hand movement arc 305.

In some implementations, hand motion/position may be determined as a user interaction event based on the positional data and whether the movement of the hand includes the wrist rotation, the arm motion, or a combination of the wrist rotation and the arm motion. For example, based on the movement of the hand, the techniques described herein determine that a user interaction event includes a scrolling action (e.g., the user scrolls the user interface elements within the user interface object 320), and implements the action based on whether the movement of the hand is associated with the wrist rotation, arm movement, or a combination of both. In an exemplary implementation, the sensitivity of tracking and determining the components of the wrist rotation may be increased such that a scroll momentum may be increased at a higher rate based on wrist rotation as opposed to only arm movement or a larger portion of arm movement. For example, determine how much change is caused by moving the hand a given distance or at a given speed based on the classified hand movements (e.g., wrist rotation vs arm motion).

In some implementations, hand motion/position may be tracked using a changing shoulder-based pivot position (e.g., pivot point 302) that is assumed to be at a position based on a fixed offset 304 from the device's current position. The fixed offset 304 may be determined using an expected fixed spatial relationship between the device and the pivot point/shoulder. For example, given the device's 310 current position, the shoulder/pivot point 302 may be determined at position X given that fixed offset 304. This may involve updating the shoulder position over time (e.g., every frame) based on the changes in the position of the device over time. The fixed offset 304, as illustrated in FIG. 3, may be determined as a fixed distance between a determined location for the top of the center of the head of the user 102 and the shoulder joint (e.g., pivot point 302).

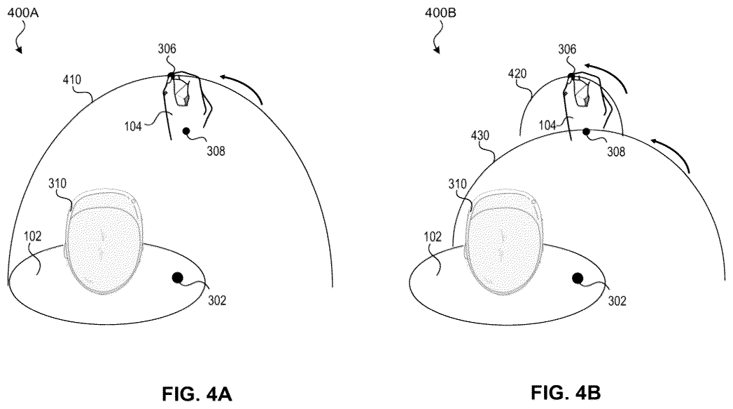

The hand tracking system described herein may interpret hand motion as a scroll based on determining scroll momentum from the hand motion. In some implementations, hand motion/position may be tracked based on classifying wrist rotation and/or arm motion and determining uniform circulation motion (UCM) associated with the pinch centroid 306 (e.g., pinch centroid 306) about a wrist (e.g., wrist joint 308), a wrist (e.g., wrist joint 308) about an arm pivot (e.g., pivot point 302), and/or a pinch centroid (e.g., pinch centroid 306) about an arm pivot (e.g., pivot point 302), as further discussed herein with reference to FIGS. 4A and 4B.

FIGS. 4A and 4B illustrate tracking methods for hand-based user input based on tracking one or more points on the hand in accordance with some implementations. In particular, FIG. 4A illustrates an example environment 400A for tracking hand motion based on arm motion (e.g., arc 410 traces UCM of a pinch centroid 306 about an arm pivot point 302) for hand-based user input. FIG. 4B illustrates an example environment 400B for tracking hand motion based on wrist rotation (e.g., arc 420 traces UCM of a pinch centroid 306 about a wrist joint 308) and arm motion (e.g., arc 430 traces UCM a wrist joint 308 about an arm pivot point 302) for hand-based user input in accordance with some

In some implementations, a sensitivity of determining the movement of the hand as the user interaction event is increased based on determining the movement of the hand includes at least some portion of wrist rotation. For example, a pinch movement can include wrist rotation and arm rotation, and the sensitivity to wrist rotation may be greater than the sensitivity to the arm rotation (e.g., whether or not there is any arm rotation). Thus, the hand tracking system described herein may increase indirect scroll sensitivity during wrist scroll. In other words, the UCM may be calculated based on wrist rotation and/or arm motion estimations, and the wrist rotation may utilize an increase gain in the calculations (e.g., higher sensitivity for the wrist motions/rotations). For example, user interface elements (e.g., application environment 322) may be scrolled more and/or more quickly for wrist-based scroll motions (e.g., scrolling/moving the application environment 322 of the user interface object 320 in FIG. 3). In some implementations, slower scroll movements may utilize the UCM for arm motion, which may reduce sensitivity to wrist errors at slow speed. In some implementations, a locked-arm scroll may utilize the UCM for arm motion, which may prevent false estimation of wrist rotation.

In some implementations, the movement of the hand is determined based on a pinch centroid about an arm pivot in response to determining that the movement of the hand is classified as an arm-based motion. For example, if just the arm is moving, and little to no wrist rotation, then the movement of hand may be classified as arm motion and the UCM may be based on using a pinch centroid (e.g., pinch centroid 306) about an arm pivot point (e.g., pivot point 302). In some implementations, the movement of the hand is determined based on a pinch centroid about an arm pivot and the pinch centroid about a wrist pivot in response to determining that the movement of the hand is classified as a wrist-based motion. For example, if just the wrist is rotating, and there is little to no arm movement (e.g., arm resting on a surface), then the movement of hand may be classified as wrist rotation. Thus, user interface elements may be scrolled more and/or more quickly for wrist-based scroll motions. If both the wrist and arm are moving, than the system may use a mix of both pinch centroid about a wrist pivot (e.g., UCM arc 420) and wrist about arm pivot (e.g., UCM arc 430), but gain the sensitivity of the wrist rotation.

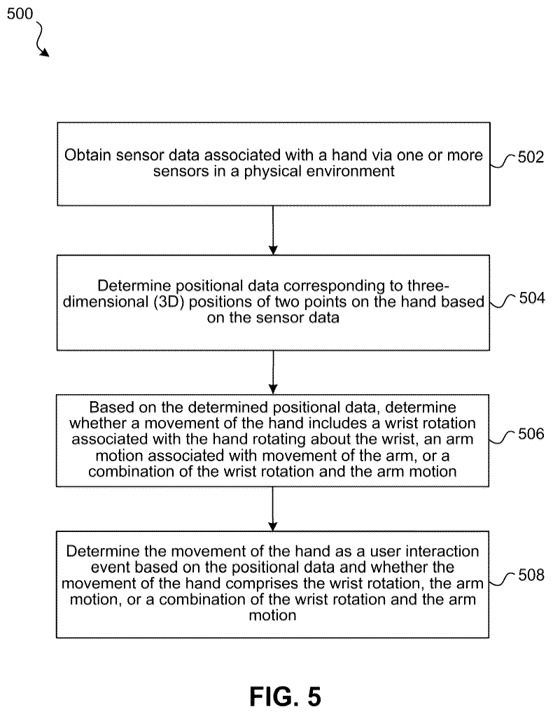

FIG. 5 is a flowchart illustrating a method 500 for determining movement of a hand for a user interaction event (e.g., a scrolling action) in accordance with some implementations. In some implementations, a device such as electronic device 110 performs method 500. In some implementations, method 500 is performed on a mobile device, desktop, laptop, HMD (e.g., device 310), or server device. The method 500 is performed by processing logic, including hardware, firmware, software, or a combination thereof. In some implementations, the method 500 is performed on a processor executing code stored in a non-transitory computer-readable medium (e.g., a memory). In some implementations, the device performing the method 500 includes a processor and one or more sensors.

At block 502, the method 500 obtains a sensor data associated with a hand via one or more sensors in a physical environment. The sensor data may be used to determine when to initiate hand tracking (e.g., when a user pinches) and a location of the hand during the tracking (e.g., to track velocity and/or track UCM of one or more points associated with the hand, wrist, or arm of the user). In some implementations, the method 500 obtains the sensor data associated with multiple portions of a hand via a sensor in a physical environment for a period of time. In some implementations, the sensor data may include user interface position data. For example, the sensor data may be associated with a position and/or an orientation of a head of a user. Additionally, or alternatively, the sensor data may be associated with a position and/or an orientation of a device worn on a head of the user, such as an HMD (e.g., device 310).

In some implementations, the sensor data may include RGB data, lidar-based depth data, and/or densified depth data. For example, sensors on a device (e.g., camera's, IMU, etc. on device 110) can capture information about the position, location, motion, pose, etc., of the head and/or body of the user 102, including tracking positions of the multiple portions of a hand. In some implementations, the user activity includes at least one of a hand position, a hand movement, an eye position, or a gaze direction.

In some implementations, the sensor data includes multiple sensor data signals. For example, one of the multiple sensor data signals may be an image signal, one of the multiple sensor data signals may be a depth signal (e.g., a structured light, a time-of-flight, or the like), one of the multiple sensor data signals may be a device motion signal (e.g., an accelerometer, an inertial measurement unit (IMU) or other tracking systems), and the like. In some implementations, the sensor data may include at least one or data signals that include light intensity image data, depth data, user interface position data, and motion data, or a combination thereof.

At block 504, the method 500 determines positional data corresponding to 3D positions of two points on the hand based on the sensor data. In some implementations, a first point of the two points on the hand includes a wrist joint, and a second point of the two points on the hand includes a pinch centroid associated with at least two fingers of the hand. For example, the two points of the hand may correspond to a wrist joint (e.g., wrist joint 308) and a pinch centroid (e.g., pinch centroid 306). In some implementations, determining the positional data corresponding to 3D positions of two points on the hand may be triggered based on identifying a pinch and/or arm movement.

At block 506, the method 500, based on the determined positional data, determine whether a movement of the hand includes a wrist rotation associated with the hand rotating about the wrist, an arm motion associated with movement of the arm, or a combination of the wrist rotation and the arm motion. In some implementations, determining the movement of the hand may involve classification of the type of movement (e.g., wrist-based or arm-based motion). Additionally, or alternatively, determining the movement of the hand may involve estimating contribution(s) of particular types of motion. For example, the motion may be less than 20% due to wrist movement, thus the type of motion may be classified as arm-motion. In some implementations, two points may be used to estimate wrist rotation (e.g., wrist joint 308 and pinch centroid point 306).

At block 508, the method 500 determines the movement of the hand as a user interaction event based on the positional data and whether the movement of the hand includes the wrist rotation, the arm motion, or a combination of the wrist rotation and the arm motion. For example, based on the movement of the hand, the techniques described herein determine that a user interaction event includes a scrolling action (e.g., the user scrolls the user interface elements within the user interface object 320 in FIG. 3), and implements the action based on whether the movement of the hand is associated with the wrist rotation, arm movement, or a combination of both. In an exemplary implementation, the sensitivity of tracking and determining the components of the wrist rotation may be increased such that a scroll momentum may be increased at a higher rate based on wrist rotation as opposed to only arm movement or a larger portion of arm movement. For example, determine how much change is caused by moving the hand a given distance or at a given speed based on the classified hand movements (e.g., wrist rotation vs arm motion).

In some implementations, a sensitivity of determining the movement of the hand as the user interaction event is increased based on determining the movement of the hand includes at least the wrist rotation. For example, a pinch movement can include wrist rotation and arm rotation, and the sensitivity to wrist rotation may be greater than the sensitivity to the arm rotation (e.g., whether or not there is any arm rotation). In other words, the UCM may be calculated based on wrist rotation and/or arm motion estimations, and the wrist rotation may utilize an increase gain in the calculations (e.g., higher sensitivity for the wrist motions/rotations). For example, user interface elements may be scrolled more and/or more quickly for wrist-based scroll motions (e.g., scrolling/moving the application environment 322 of the user interface object 320 in FIG. 3). In some implementations, slower scroll movements may utilize the UCM for arm motion, which may reduce sensitivity to wrist errors at slow speed. In some implementations, a locked-arm scroll may utilize the UCM for arm motion, which may prevent false estimation of wrist rotation.

In some implementations, determining the movement of the hand based on the determined positional data includes determining whether the movement of the hand is classified as a wrist-based motion or an arm-based motion. For example, a type of motion may be used to select a reference point, e.g., a pivot point or a coordinate system. In some implementations, the movement of the hand is determined based on a pinch centroid about an arm pivot in response to determining that the movement of the hand is classified as an arm-based motion. For example, if just the arm is moving, and little to no wrist rotation, then the movement of hand may be classified as arm motion and the UCM may be based on using a pinch centroid (e.g., pinch centroid 306) about an arm pivot point (pivot point 302). In some implementations, the movement of the hand is determined based on a pinch centroid about an arm pivot and the pinch centroid about a wrist pivot in response to determining that the movement of the hand is classified as a wrist-based motion. For example, if just the wrist is rotating, and there is little to no arm movement (e.g., arm resting on a surface), then the movement of hand may be classified as wrist rotation. Thus, user interface elements may be scrolled more and/or more quickly for wrist-based scroll motions. If both the wrist and arm are moving, than the system may use a mix of both pinch centroid about a wrist pivot (e.g., UCM arc 420) and wrist about arm pivot (e.g., UCM arc 430), but gain the sensitivity of the wrist rotation.

In some implementations, determining whether the movement of the hand includes wrist rotation includes determining a type of motion based on an amount of wrist movement compared to a threshold. For example, estimating contribution(s) of particular types of motion, e.g., motion is less than 20% due to wrist movement.

In some implementations, the method 500 further includes determining a velocity of the movement of the hand, and updating the positional data corresponding to the 3D positions of the two points on the hand based on the velocity of the hand exceeding a threshold. For example, to avoid abrupt or noticeable changes during a scrolling action, the system may reconcile only when the hand is moving very fast (e.g., above a threshold speed within the head space associated with the device 310).

In some implementations, determining the movement of the hand is based on the tracking a pivot point. For example, determining a movement of the hand may be based on a determined angular change (e.g., Δyaw) and/or a distance change (e.g., Δradius) from a pivot point (e.g., pivot point 302, wrist joint 308, etc.).

In exemplary implementations, hand tracking (e.g., determining the positional data corresponding to the 3D positions of two points on the hand) may occur, initiate, conclude, etc., based on user interaction events and/or gestures, such as a pinch movement. In particular, in some implementations, determining the positional data corresponding to the 3D positions of two points on the hand is initiated based on identifying a pinch action associated with two or more fingers of the hand. For example, as illustrated in FIG. 3, a detected pinch signal may initiate a “scroll gesture” action (e.g., at hand representation 104A, user 102 is focused on the user interface object 320A at a first moment in time and makes a pinch and scroll movement, such as a flick of the wrist). In some implementations, determining the movement of the hand as the user interaction event is initiated based on a first user action (e.g., a pinch signal to initiate a “scroll gesture”). In some implementations, determining the movement of the hand is stopped based on a second user interaction event. For example, a pinch signal ceases, thus the scroll gesture ends and the object that the user 102 grabbed (e.g., user interface object 320B) is placed at the 3D location the pinch signal ceases (e.g., the user 102 stops/releases the pinch). In some implementations, the first user interaction event or the second user interaction event is determined based on the first sensor data signal associated with the hand. For example, the first sensor data associated with the hand (RGB data, lidar-based depth data, and/or densified depth data) may be used to determine when to initiate hand tracking (e.g., when user pinches) and the location of the hand during the tracking.

In some implementations, the method 500 may further include obtaining a second sensor data signal associated with a pose (i.e., position and orientation) of a head or a device worn on the head (e.g., device 310) via the one or more sensors in the physical environment. In some implementations, the method 500 may further include determining changes in the pose of the head or the device and updating the position of the pivot point based on detecting rotation or movement of the head or the device (e.g., every frame) based on the determined changes in the pose of the head or the device. In other words, the hand tracking system and techniques described herein may update the tracking of the hand(s) based a on a viewpoint change (e.g., the HMD or head moving while tracking).

In exemplary implementations, the hand tracking system may track two hands and two respective wrist pivot points and two pinch centroids simultaneously and separately. In some implementations, the hand is a first hand, wherein the sensor data is obtained during a period of time and the movement of the hand is determined during the period of time, and the method 500 may further include obtaining another sensor data associated with a second hand via the one or more sensors in the physical environment during the period of time, determining additional positional data corresponding to 3D positions of two points on the second hand (e.g., corresponding to the wrist joint and pinch centroid) based on the sensor data (associated with a second hand) during the period of time, and determining the movement of the second hand as the user interaction event based on the additional positional data and whether the movement of the second hand includes the second hand rotating about the wrist. For example, the hand tracking system described herein may be able to track a right arm, shoulder, wrist, and pinch together as a first tracking process, and track a left arm, shoulder, wrist, and pinch together as another tracking process.

In some implementations, determining the movement of the hand as the user interaction event based on the positional data and whether the movement of the hand includes the hand rotating about the wrist is further based on determining a direction of a gaze. For example, updating the tracking of the biomechanical points (e.g., wrist, pinch, and/or shoulder location) may be improved based on determining eye movement and gaze behaviors (e.g., focusing on an area of an object). For example, based on specular illumination of an eye, the device 310 may obtain eye gaze characteristic data via a high-power sensor, such as a complementary metal oxide semiconductor (CMOS).

Additionally, or alternatively, the device 310 may obtain eye gaze characteristic data via a low-power sensor, such as a photodiode.

In some implementations, determining the movement of the hand as the user interaction event based on the positional data and whether the movement of the hand includes the hand rotating about the wrist is further based on tracking a viewpoint or a pose of the hand. For example, updating the tracking of the pivot point may be improved based on tracking a pose of each hand and/or a viewpoint of where the hand may be pointing (e.g., pointing to an area of a user interface element).

In some implementations, the method 500 may further include determining a velocity of the movement of the hand and updating the positions of the pivot points based on the velocity of the hand exceeding a threshold. For example, the pivot point (e.g., wrist, pinch, and/or shoulder location) may be reconciled (e.g., converging current pivot point to the fixed offset position) to avoid abrupt/noticeable changes. Thus, the hand tracking system may reconcile only when the hand is moving very fast (e.g., above a threshold speed in head space). Thus, when the hand is moving quickly, a user may be less sensitive to false motion, as the desired behavior is to minimize significant leakage or drift of tracking and updating the location of a pivot point during fast hand motion. In some implementations, a gradual linear ramp of the angular speed of a pinch centroid may be used as a threshold to trigger the reconciling (e.g., as the hand moves faster, the hand tracking system may converge more and more quickly). For example, a linear ramp may be tuned so that the pivot point (shoulder) fully converges to the fixed offset pivot point (shoulder with respect to the head) if the respective hand is moving at 1 m/s with respect to the head for about one second.

In some implementations, the method 500 further includes identifying a position of a pivot point based on a predetermined spatial relationship and the pose of the head or the device worn on the head. For example, tracking a position of a pivot point that may be associated with a shoulder corresponding to the hand (e.g., pivot point 302 of FIG. 3). In some implementations, the spatial relationship of the pivot point with relation to the head of the user or the device worn on the head of the user (e.g., device 310 worn as an HMD as illustrated in FIG. 3) may be a fixed spatial relationship, such as an offset distance (e.g., offset 304). In some implementations, the pivot point may be updated as head/device rotates/moves (e.g., every frame) based on changes in head/device pose.

In some implementations, determining movement of the hand includes generating a 3D representation of the multiple portions of the hand. For example, a skeleton of the hand may be determined, and the hand tracking system can track velocities of portions of that 3D representation (e.g., track different fingers of the skeleton/3D representation).

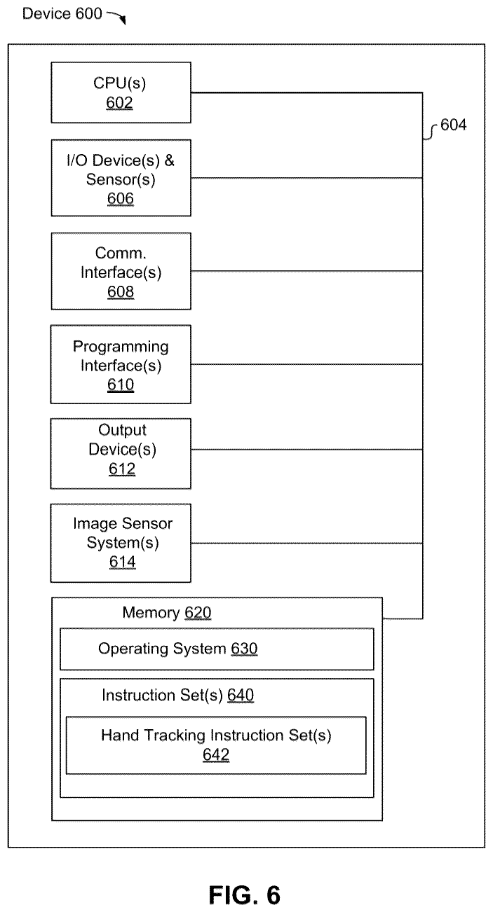

FIG. 6 is a block diagram of electronic device 600. Device 600 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 600 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 610, one or more output device(s) 612, one or more interior and/or exterior facing image sensor systems 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 612 include one or more displays configured to present a view of a 3D environment to the user. In some implementations, the one or more device(s) 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 600 includes a single display. In another example, the device 600 includes a display for each eye of the user.

In some implementations, the one or more output device(s) 612 include one or more audio producing devices. In some implementations, the one or more output device(s) 612 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 612 may additionally or alternatively be configured to generate haptics.

In some implementations, the one or more image sensor systems 614 are configured to obtain image data that corresponds to at least a portion of a physical environment. For example, the one or more image sensor systems 614 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 614 further include illumination sources that emit light, such as a flash. In various implementations, the one or more image sensor systems 614 further include an on-camera image signal processor (ISP) configured to execute a plurality of processing operations on the image data.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 includes a non-transitory computer readable storage medium.

In some implementations, the memory 620 or the non-transitory computer readable storage medium of the memory 620 stores an optional operating system 630 and one or more instruction set(s) 640. The operating system 630 includes procedures for handling various basic system services and for performing hardware dependent tasks. In some implementations, the instruction set(s) 640 include executable software defined by binary information stored in the form of an electrical charge. In some implementations, the instruction set(s) 640 are software that is executable by the one or more processing units 602 to carry out one or more of the techniques described herein.

The instruction set(s) 640 includes hand tracking instruction set(s) 642 configured to, upon execution, for determining motion of a hand as described herein (e.g., interprets the hand motion as a scroll based on determining scroll momentum from the hand motion). The instruction set(s) 640 may be embodied as a single software executable or multiple software executables.

Although the instruction set(s) 640 are shown as residing on a single device, it should be understood that in other implementations, any combination of the elements may be located in separate computing devices. Moreover, the FIG. is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

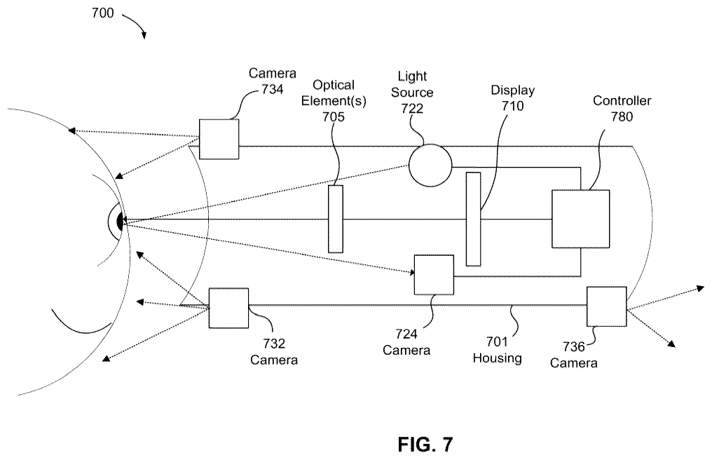

FIG. 7 illustrates a block diagram of an exemplary head-mounted device 700 in accordance with some implementations. The head-mounted device 700 includes a housing 701 (or enclosure) that houses various components of the head-mounted device 700. The housing 701 includes (or is coupled to) an eye pad (not shown) disposed at a proximal (to the user 102) end of the housing 701. In various implementations, the eye pad is a plastic or rubber piece that comfortably and snugly keeps the head-mounted device 700 in the proper position on the face of the user 102 (e.g., surrounding the eye of the user 102).

The housing 701 houses a display 710 that displays an image, emitting light towards or onto the eye of a user 102. In various implementations, the display 710 emits the light through an eyepiece having one or more optical elements 705 that refracts the light emitted by the display 710, making the display appear to the user 102 to be at a virtual distance farther than the actual distance from the eye to the display 710. For example, optical element(s) 705 may include one or more lenses, a waveguide, other diffraction optical elements (DOE), and the like. For the user 102 to be able to focus on the display 710, in various implementations, the virtual distance is at least greater than a minimum focal distance of the eye (e.g., 7 cm). Further, in order to provide a better user experience, in various implementations, the virtual distance is greater than 1 meter.

The housing 701 also houses a tracking system including one or more light sources 722, camera 724, camera 732, camera 734, camera 736, and a controller 780. The one or more light sources 722 emit light onto the eye of the user 102 that reflects as a light pattern (e.g., a circle of glints) that may be detected by the camera 724. Based on the light pattern, the controller 780 may determine an eye tracking characteristic of the user 102. For example, the controller 780 may determine a gaze direction and/or a blinking state (eyes open or eyes closed) of the user 102. As another example, the controller 780 may determine a pupil center, a pupil size, or a point of regard. Thus, in various implementations, the light is emitted by the one or more light sources 722, reflects off the eye of the user 102, and is detected by the camera 724. In various implementations, the light from the eye of the user 102 is reflected off a hot mirror or passed through an eyepiece before reaching the camera 724.

The display 710 emits light in a first wavelength range and the one or more light sources 722 emit light in a second wavelength range. Similarly, the camera 724 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 710 by looking at it), provide foveated rendering (e.g., present a higher resolution in an area of the display 710 the user 102 is looking at and a lower resolution elsewhere on the display 710), or correct distortions (e.g., for images to be provided on the display 710).

In various implementations, the one or more light sources 722 emit light towards the eye of the user 102 which reflects in the form of a plurality of glints.

In various implementations, the camera 724 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 724 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 732, camera 734, and camera 736 are frame/shutter-based cameras that, at a particular point in time or multiple points in time at a frame rate, may generate an image of the face of the user 102 or capture an external physical environment. For example, camera 732 captures images of the user's face below the eyes, camera 734 captures images of the user's face above the eyes, and camera 736 captures the external environment of the user (e.g., environment 100 of FIG. 1). The images captured by camera 732, camera 734, and camera 736 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a device having a processor and one or more sensors:
obtaining sensor data associated with a hand via the one or more sensors in a physical environment, the hand comprising a wrist and is associated with an arm;
determining positional data corresponding to three-dimensional (3D) positions of two points on the hand based on the sensor data;
based on the determined positional data, determining whether a movement of the hand comprises a wrist rotation associated with the hand rotating about the wrist, an arm motion associated with movement of the arm, or a combination of the wrist rotation and the arm motion; and
determining the movement of the hand as a user interaction event based on the positional data and whether the movement of the hand comprises the wrist rotation, the arm motion, or a combination of the wrist rotation and the arm motion.

2. The method of claim 1, wherein a sensitivity of determining the movement of the hand as the user interaction event is increased based on determining the movement of the hand comprises at least the wrist rotation.

3. The method of claim 1, wherein determining the movement of the hand based on the determined positional data comprises determining whether the movement of the hand is classified as a wrist-based motion or an arm-based motion.

4. The method of claim 3, wherein the movement of the hand is determined based on a pinch centroid about an arm pivot in response to determining that the movement of the hand is classified as an arm-based motion.

5. The method of claim 3, wherein the movement of the hand is determined based on a pinch centroid about an arm pivot and the pinch centroid about a wrist pivot in response to determining that the movement of the hand is classified as a wrist-based motion.

6. The method of claim 1, wherein determining whether the movement of the hand comprises wrist rotation comprises determining a type of motion based on an amount of wrist movement compared to a threshold.

7. The method of claim 1, wherein the user interaction event comprises a scrolling action.

8. The method of claim 1, wherein determining the movement of the hand is based on an angular change.

9. The method of claim 1, wherein a first point of the two points on the hand comprises a wrist joint, and a second point of the two points on the hand comprises a pinch centroid associated with at least two fingers of the hand.

10. The method of claim 1, wherein determining the positional data corresponding to the 3D positions of two points on the hand is initiated based on identifying a pinch action associated with two or more fingers of the hand.

11. The method of claim 1, wherein determining the movement of the hand as the user interaction event is initiated based on a first user action.

12. The method of claim 1, wherein determining the movement of the hand is stopped based on a second user action.

13. The method of claim 1, further comprising:
determining a velocity of the movement of the hand; and
updating the positional data corresponding to the 3D positions of the two points on the hand based on the velocity of the hand exceeding a threshold.

14. The method of claim 1, further comprising:
obtaining a second sensor data signal associated with a pose of a head or a device worn on the head via the one or more sensors in the physical environment.

15. The method of claim 14, further comprising:
determining changes in the pose of the head or the device; and
updating the positional data corresponding to the 3D positions of the two points on the hand based on detecting rotation or movement of the head or the device based on the determined changes in the pose of the head or the device.

16. The method of claim 1, wherein the hand is a first hand, wherein the sensor data is obtained during a period of time and the movement of the hand is determined during the period of time, the method further comprising:
obtaining another sensor data associated with a second hand via the one or more sensors in the physical environment during the period of time;
determining additional positional data corresponding to 3D positions of two points on the second hand based on the sensor data during the period of time; and
determining the movement of the second hand as the user interaction event based on the additional positional data and whether the movement of the second hand comprises the second hand rotating about the wrist.

17. The method of claim 1, wherein determining the movement of the hand as the user interaction event based on the positional data and whether the movement of the hand comprises the hand rotating about the wrist is further based on determining a direction of a gaze.

18. The method of claim 1, wherein determining the movement of the hand as the user interaction event based on the positional data and whether the movement of the hand comprises the hand rotating about the wrist is further based on tracking a viewpoint or a pose of the hand.

19. The method of claim 1, wherein determining movement of the hand comprises generating a 3D representation of the multiple portions of the hand.

20. The method of claim 1, wherein the sensor data comprises multiple sensor data signals.

21. The method of claim 1, wherein the sensor data comprises at least one of light intensity image data, depth data, user interface position data, motion data, or a combination thereof.

22. The method of claim 1, wherein the device comprises a head mounted device (HMD).

23. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining sensor data associated with a hand via the one or more sensors in a physical environment, the hand comprising a wrist and is associated with an arm;
determining positional data corresponding to three-dimensional (3D) positions of two points on the hand based on the sensor data;
based on the determined positional data, determining whether a movement of the hand comprises a wrist rotation associated with the hand rotating about the wrist, an arm motion associated with movement of the arm, or a combination of the wrist rotation and the arm motion; and
determining the movement of the hand as a user interaction event based on the positional data and whether the movement of the hand comprises the wrist rotation, the arm motion, or a combination of the wrist rotation and the arm motion.

24. The device of claim 23, wherein a sensitivity of determining the movement of the hand as the user interaction event is increased based on determining the movement of the hand comprises at least the wrist rotation.

25. A non-transitory computer-readable storage medium, storing program instructions executable on a device to perform operations comprising:
obtaining sensor data associated with a hand via the one or more sensors in a physical environment, the hand comprising a wrist and is associated with an arm;
determining positional data corresponding to three-dimensional (3D) positions of two points on the hand based on the sensor data;
based on the determined positional data, determining whether a movement of the hand comprises a wrist rotation associated with the hand rotating about the wrist, an arm motion associated with movement of the arm, or a combination of the wrist rotation and the arm motion; and
determining the movement of the hand as a user interaction event based on the positional data and whether the movement of the hand comprises the wrist rotation, the arm motion, or a combination of the wrist rotation and the arm motion.
